(19) United States
(12) Patent Application Publication
(10) Pub. No.: US 2026/0302741 A1
(43) Pub. Date: Oct. 1, 2026

(54) THREADED ROD CONNECTOR SYSTEM FOR MODULAR ASSEMBLY OF VARIABLE-LENGTH CABLE MANAGEMENT TRAYS

(71) Applicant: Renexus Media LLC DBA Ascrono, St. Petersburg, FL (US)

(72) Inventor: Tobias Heckmann, Samut Prakan (TH)

(21) Appl. No.: 19/095,071

(22) Filed: Mar. 31, 2025

(51) Int. Cl. H02G 3/04

(52) U.S. Cl. CPC H02G 3/0456

(57) ABSTRACT

A modular support structure system enables efficient manufacturing of cable management trays in various lengths. The system includes threaded support bars of standardized length (approximately 33 cm), threaded connector pieces that join the bars, a flexible material with integrated loops through which the assembled bars pass, and end caps that attach to the terminal ends of the outermost bars. By varying the number of support bars and connectors used, manufacturers can produce trays of different lengths (33 cm, 66 cm, or 99 cm) using standardized components, reducing manufacturing complexity and inventory requirements. The system can be disassembled for compact packaging and shipping, then reassembled by the end user. The threaded connections provide structural rigidity, while the distribution of support bars along the flexible material prevents sagging and maintains the desired shape during use, even when loaded with cables and electronic accessories.

### FIELD OF THE INVENTION

The present invention relates generally to support structures for organizational products, and more particularly to a modular support structure system that enables efficient manufacturing of cable management trays in various lengths while maintaining structural integrity and aesthetic appeal.

### BACKGROUND OF THE INVENTION

In modern office and home environments, the proliferation of electronic devices has led to an increasing need for effective cable management solutions. Unmanaged cables can create workspace clutter, pose tripping hazards, and complicate device connections. Various cable management systems have been developed to address these issues, including under-desk trays and organizers.

Cable management trays are often installed in spaces with varying dimensions, requiring manufacturers to offer these products in different lengths to accommodate diverse user setups. Traditional approaches to manufacturing variable-length cable trays typically involve completely separate production lines for each size variant, leading to increased manufacturing complexity, inventory requirements, and production costs. Alternatively, some manufacturers produce adjustable products that can be modified by the end user, but these often sacrifice stability and aesthetic appeal.

Furthermore, cable management trays with elongated support structures face challenges related to packaging, shipping, and storage. Full-length rigid trays require large packaging, increasing shipping costs and retail space requirements, while potentially limiting customer purchase options based on vehicle cargo capacity.

There exists a need for an improved modular support structure system for cable management trays that allows manufacturers to efficiently produce trays in various lengths using standardized components, while maintaining structural integrity, aesthetic appeal, and providing convenient packaging solutions.

### SUMMARY OF THE INVENTION

The present invention provides a modular support structure system that enables efficient manufacturing of cable management trays in multiple lengths using standardized components. The system includes threaded support bars, threaded connector pieces, fabric with integrated loops, and end caps that work together to create a complete support structure for a cable management tray.

In one aspect, the invention comprises a set of threaded support bars of standardized length, threaded connector pieces that join the support bars, and a flexible material with integrated loops through which the assembled support bars pass. End caps attach to the terminal ends of the outermost support bars, preventing the flexible material from sliding off and providing a finished appearance.

This modular approach allows manufacturers to produce cable management trays of various lengths by simply adding or removing support bars and connectors, without requiring completely different components or manufacturing processes for each length variant. For example, a manufacturer can offer cable trays in lengths such as 32 cm, 64 cm, or 96 cm by using one, two, or three support bars with appropriate connectors. The system also facilitates compact packaging for shipping and storage, as the components can be disassembled and reassembled by the end user.

### BRIEF DESCRIPTION OF THE DRAWINGS

FIG. 1 is a perspective view of an assembled cable management tray showing the threaded support bars with end caps passing through fabric loops to form a complete tray structure.

FIG. 2 is an exploded perspective view showing the component parts of the modular support structure system including multiple threaded support bars, end caps, and the fabric tray.

FIG. 3A-3D show top views of the modular support structure system in various length configurations, where: FIG. 3A shows a small tray with a single support bar; FIG. 3B shows a medium tray with two connected support bars; FIG. 3C shows a larger tray with three connected support bars; and FIG. 3D shows a view with the internal connection structure visible.

### DETAILED DESCRIPTION OF THE INVENTION

The following detailed description is presented with reference to the accompanying drawings, which form a part of this specification and show, by way of illustration, specific embodiments in which the invention may be practiced.

Referring to the drawings, the modular support structure system for cable management trays comprises several primary components that work together to create a complete support structure of variable length:

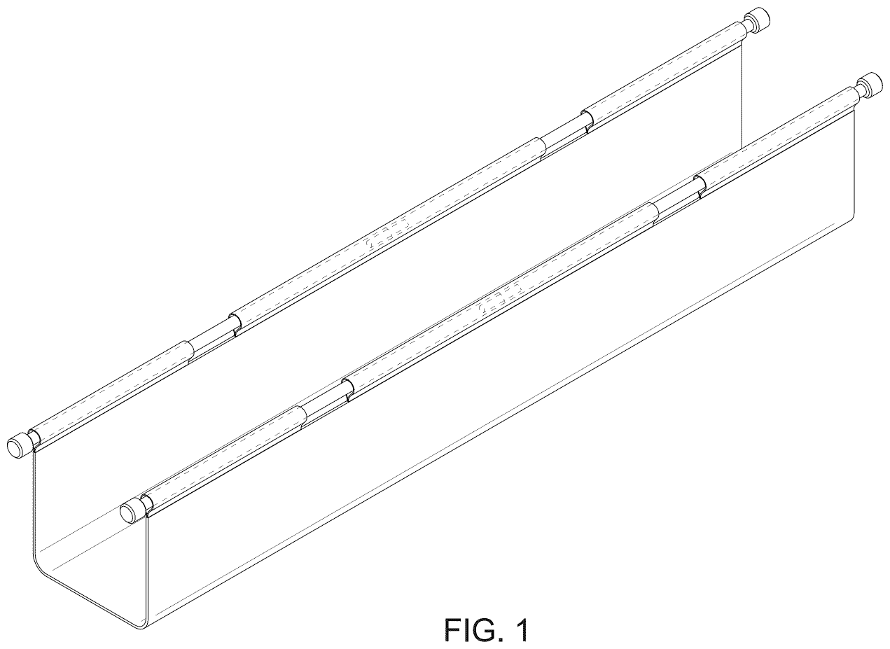

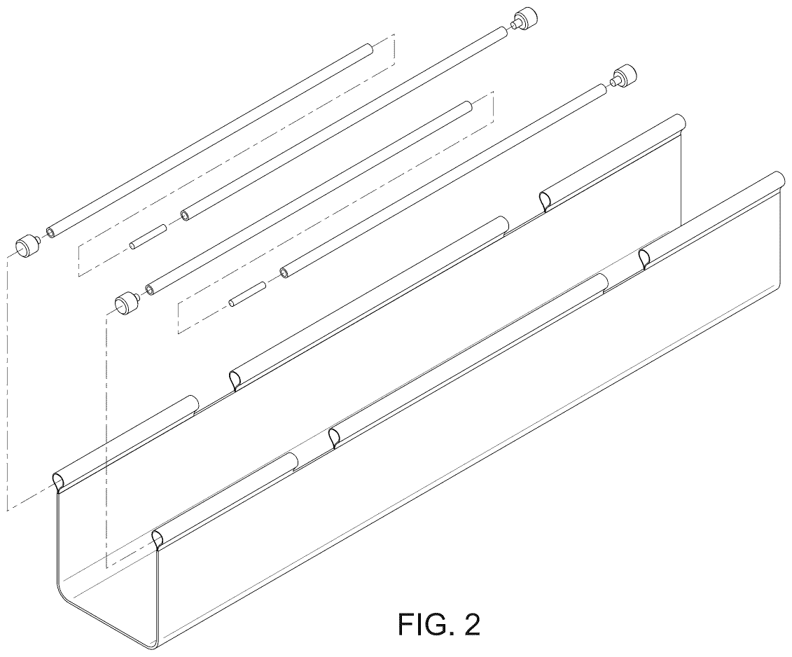

The system includes a plurality of threaded support bars of standardized length, typically approximately 33 cm long, as illustrated in FIG. 2. These support bars are typically made of metal or other rigid material and include external or internal threading at one or both ends. The support bars provide the primary structural support for the cable management tray and determine the overall strength and rigidity of the assembled product, as shown in FIG. 1.

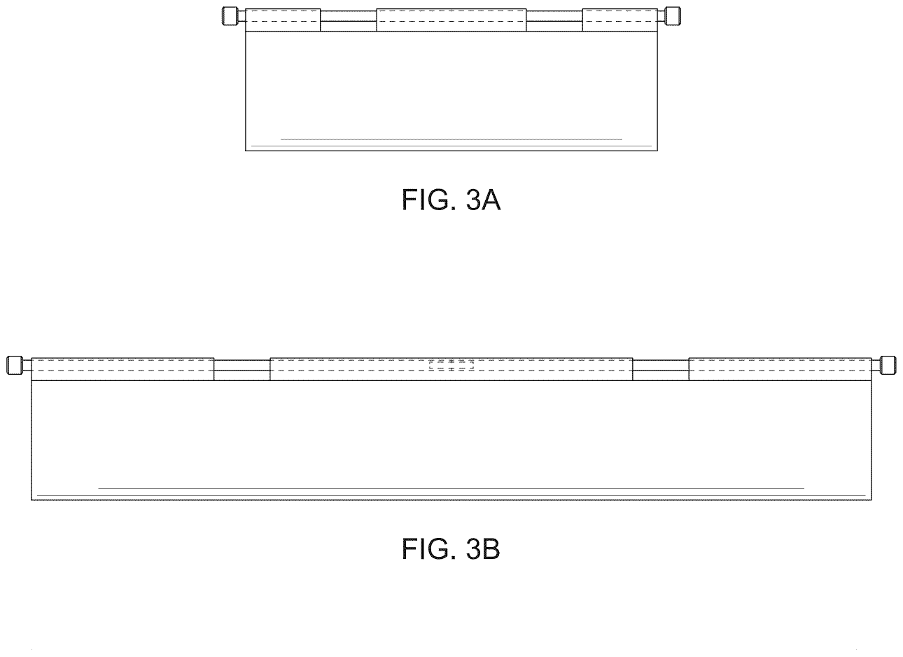

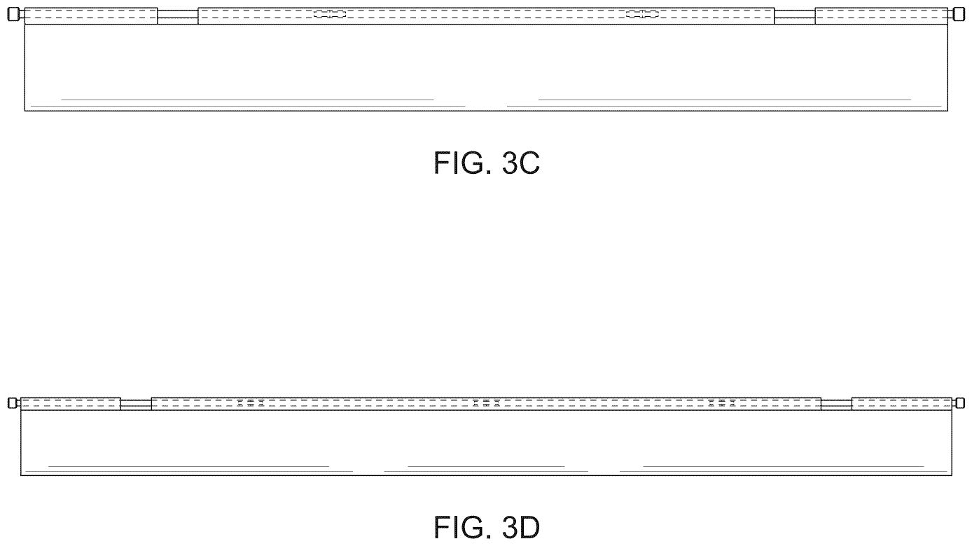

Threaded connector pieces are designed to join the support bars together, as can be seen in the transition points in FIG. 3B, FIG. 3C, and FIG. 3D. These connector pieces include threading that is complementary to the threading on the support bars, allowing secure connection between two support bars. The connector pieces may be cylindrical, hexagonal, or another shape that facilitates secure connection and, optionally, ease of rotation during assembly.

A flexible material, such as fabric, includes integrated loops or channels through which the assembled support bars pass, as depicted in FIG. 1. These loops are spaced appropriately to ensure proper positioning of the support bars and to maintain the desired shape of the cable management tray when the system is assembled. The flexible material forms the functional surface of the tray, creating a space where cables and accessories can be stored and organized.

End caps attach to the terminal ends of the outermost support bars, as shown in FIG. 1 and FIG. 3A-3D. These end caps serve multiple functions: they cover the threaded openings of the support bars for aesthetic purposes; they prevent the flexible material from sliding off the support bars; and they provide a finished appearance to the cable management tray. The end caps are designed to be larger than the loops or channels in the flexible material, thereby keeping the flexible material securely positioned on the support bars.

The modular support structure system functions by allowing manufacturers to produce cable management trays of different lengths using the same standardized components. For shorter trays, fewer support bars and connector pieces are used, as shown in FIG. 3A; for longer trays, additional support bars and connector pieces are incorporated, as illustrated in FIG. 3B and FIG. 3C. The flexible material is appropriately sized for each tray length. For example, a small tray might use one 33 cm support bar with end caps (FIG. 3A), a medium tray might use two support bars connected with one connector piece for a length of approximately 66 cm (FIG. 3B), and a large tray might use three support bars connected with two connector pieces for a length of approximately 99 cm (FIG. 3C).

During manufacturing, the appropriate number of support bars are connected using the threaded connector pieces, as shown in the exploded view in FIG. 2. The assembled support bar structure is then threaded through the loops or channels in the flexible material. End caps are attached to the terminal ends of the outermost support bars, securing the flexible material in position and completing the assembly of the cable management tray, as shown in the fully assembled view in FIG. 1.

For packaging and shipping, the system can be disassembled into its component parts, allowing for compact packaging, as illustrated by the separated components in FIG. 2. End users can easily reassemble the system by following the reverse process of disassembly, connecting the support bars with the connector pieces, threading the assembly through the loops in the flexible material, and attaching the end caps.

In addition to facilitating variable-length product manufacturing, the system provides significant structural advantages for cable management trays. The threaded connections between support bars and connector pieces create a rigid assembly that resists bending and torsion, while the distribution of support bars along the length of the flexible material prevents sagging and maintains the desired shape of the tray during use, even when loaded with cables, power bricks, and other electronic accessories.

Furthermore, while designed primarily for cable management trays, the system is adaptable to various product applications. The basic components can be utilized in different configurations and with different flexible materials to create a wide range of products that benefit from variable-length support structures.

1. A modular support structure system, comprising: at least one threaded support bar; a flexible material comprising a plurality of loops; at least one end cap configured to attach to a terminal end of one of the threaded support bars; and when more than one threaded support bar is used, at least one threaded connector piece configured to join two of the threaded support bars; wherein the threaded support bars are configured to pass through the plurality of loops in the flexible material, and the at least one end cap is configured to prevent the flexible material from sliding off the threaded support bars.

2. The modular support structure system of claim 1, wherein the threaded support bars comprise external threading at at least one end.

3. The modular support structure system of claim 1, wherein the at least one threaded connector piece comprises internal threading configured to engage with the threaded support bars.

4. The modular support structure system of claim 1, wherein the flexible material comprises fabric.

5. The modular support structure system of claim 1, wherein the at least one end cap has a dimension larger than a corresponding dimension of the loops in the flexible material.

6. The modular support structure system of claim 1, wherein the system is configurable in multiple lengths by varying the number of threaded support bars and threaded connector pieces used in the assembly.

7. The modular support structure system of claim 1, wherein the system is configured to be disassembled for packaging and reassembled by an end user.

8. The modular support structure system of claim 1, wherein the flexible material forms a tray when supported by the threaded support bars.

9. The modular support structure system of claim 1, wherein the threaded support bars are of substantially equal length.

10. The modular support structure system of claim 1, wherein the at least one end cap is configured to cover a threaded opening of the threaded support bar to which it attaches.

11. A method of manufacturing products of variable lengths, comprising: providing a plurality of threaded support bars of standardized length; providing a plurality of threaded connector pieces; determining a desired product length; selecting a number of threaded support bars and threaded connector pieces based on the desired product length; connecting the selected threaded support bars using the selected threaded connector pieces to form a support structure of the desired product length; providing a flexible material with loops sized to accommodate the support structure; threading the support structure through the loops in the flexible material; and attaching end caps to terminal ends of the outermost threaded support bars of the support structure.

12. The method of claim 11, further comprising packaging the threaded support bars, threaded connector pieces, flexible material, and end caps in a disassembled state for shipment.

13. The method of claim 12, further comprising providing assembly instructions for an end user to reassemble the support structure.

14. The method of claim 11, wherein the flexible material is selected based on the determined desired product length.

15. The method of claim 11, wherein the flexible material comprises fabric with reinforcing elements.

16. A product support system, comprising: a support structure assembly comprising multiple elongated support members joined by connectors to create a continuous support of a desired length; a flexible cover comprising channels through which the support structure assembly passes; and terminal elements attached to ends of the support structure assembly, the terminal elements having dimensions larger than the channels of the flexible cover to retain the flexible cover on the support structure assembly; wherein the product support system is configurable in different lengths by adjusting the number of elongated support members and connectors in the support structure assembly.

17. The product support system of claim 16, wherein the elongated support members comprise threaded ends, and the connectors comprise complementary threading for joining the elongated support members.

18. The product support system of claim 16, wherein the flexible cover comprises a material that can be folded or rolled for packaging when removed from the support structure assembly.

19. The product support system of claim 16, wherein the terminal elements comprise decorative end caps that conceal connection points of the support structure assembly.

20. The product support system of claim 16, wherein the flexible cover, when supported by the support structure assembly, forms a functional surface for supporting items.
